(19) United States
(12) Patent Application Publication
(10) Pub. No.: US 2020/0293424 A1
(43) Pub. Date: Sep. 17, 2020

(54) SYSTEMS AND METHODS FOR EVALUATING PERFORMANCE OF MODELS

(71) Applicant: BEIJING DIDI INFINITY TECHNOLOGY AND DEVELOPMENT CO., LTD., Beijing (CN)

(72) Inventor: Lingyu ZHANG, Beijing (CN)

(73) Assignee: BEIJING DIDI INFINITY TECHNOLOGY AND DEVELOPMENT CO., LTD., Beijing (CN)

(21) Appl. No.: 16/886,806

(22) Filed: May 29, 2020

Related U.S. Application Data
(63) Continuation of application No. PCT/CN2017/113652, filed on Nov. 29, 2017.

(51) Int. Cl. G06F 11/34; G06F 17/18

(52) U.S. Cl. CPC G06F 11/3447; G06F 17/18

(57) ABSTRACT

A system and method for evaluating performance of difference models. The method may include: obtaining, by at least one computer, a first sample set and a second sample set; dividing, by the at least one computer, the first sample set into a plurality of first sample subsets, each first sample subset providing an average first sample subset characteristic value; dividing, by the at least one computer, the second sample set into a plurality of second sample subsets; each second sample subset providing an average second sample subset characteristic value; determining, by the at least one computer, a final model between the first model and the second model based on an average difference, a significance level, and a confidence interval between the first model and the second model.

### CROSS-REFERENCE TO REATED APPLICATIONS

This application is a continuation of International Application No. PCT/CN2017/113652, filed on Nov. 29, 2017, the entire contents of which are incorporated herein by reference.

### TECHNICAL FIELD

The present disclosure generally relates to technology field of model performance evaluation, and in particular, systems and methods for determining a better model based on process results of samples among different models.

### BACKGROUND

Most business indexes of a company are directly or indirectly supported by algorithms and/or strategy models. In order to improve a certain business index, a feasible way is to replace an old model with a new one. However, the replacement of models may result in a comparable or even worse result. Therefore, it is desirable to provide systems and methods for effectively evaluating performance of different models.

### SUMMARY

According to an aspect of the present disclosure, a system may include one or more storage media including a set of instructions for model evaluation, and one or more processors configured to communicate with the one or more storage media, wherein when executing the set of instructions, the one or more processors are directed to: obtain a first sample set and a second sample set, wherein the first sample set includes a plurality of first samples based on a first model, the second sample set includes a plurality of second samples based on a second model, and each of the first and second samples includes a characteristic value; divide the first sample set into a plurality of first sample subsets, each first sample subset providing an average first sample subset characteristic value; divide the second sample set into a plurality of second sample subsets; each second sample subset providing an average second sample subset characteristic value; determine a final model between the first model and the second model based on an average difference, a significance level, and a confidence interval between the first model and the second model, wherein the average difference, the significance level, and the confidence interval are based on the average first sample subset characteristic values and the average second sample subset characteristic values.

In some embodiments, to obtain the first sample set and the second sample set, for each sample, the one or more processors are further directed to: obtain a request associated with a first randomizing parameter; assign the request to the first model or the second model based on the first randomizing parameter by using a first randomizing function; generate the characteristic value for the sample based on the request and the model to which the request is assigned.

In some embodiments, the first randomizing parameter is user ID and the first randomizing function is to assign the request by even or odd number in a last digit of the user ID.

In some embodiments, to determine the average difference based on the average first sample subset characteristic values and the average second sample subset characteristic values, the one or more processors are directed to: determine a first evaluation parameter related to central tendency of the average first sample subset characteristic values; determine a second evaluation parameter related to the central tendency of the average second sample subset characteristic values; determine the average difference based on the first evaluation parameter and the second evaluation parameter.

In some embodiments, to determine the significance level based on the average first sample subset characteristic values and the average second sample subset characteristic values, the one or more processors are directed to: determine a third evaluation parameter related to the central tendencies of the average first sample subset characteristic values and the average second sample subset characteristic values; determine a first error based on difference between the first evaluation parameter and the third evaluation parameter and difference between the second evaluation parameter and the third evaluation parameter; determine a second error based on difference between the average first sample subset characteristic value and the third evaluation parameter and difference between the average second sample subset characteristic value and the third evaluation parameter; determine the significance level based on the first error and the second error.

In some embodiments, to determine the second error, the one or more processors are further directed to: determine a degree of freedom based on total number of the first sample subsets and the second sample subsets; determine the second error based on the degree of freedom.

In some embodiments, to determine the confidence interval, the one or more processors are directed to: obtain a degree of confidence; determine the confidence interval associated with the degree of confidence based on the average difference, the degree of freedom and the second error.

In some embodiments, to determine the confidence interval, the one or more processors are directed to: determine the confidence interval associated with the degree of confidence based on Student's t-distribution.

According to another aspect of the present disclosure, a method for model evaluation may include: obtaining, by at least one computer, a first sample set and a second sample set, wherein the first sample set includes a plurality of first samples based on a first model, the second sample set includes a plurality of second samples based on a second model, and each of the first and second samples includes a characteristic value; dividing, by the at least one computer, the first sample set into a plurality of first sample subsets, each first sample subset providing an average first sample subset characteristic value; dividing, by the at least one computer, the second sample set into a plurality of second sample subsets; each second sample subset providing an average second sample subset characteristic value; determining, by the at least one computer, a final model between the first model and the second model based on an average difference, a significance level, and a confidence interval between the first model and the second model, wherein the average difference, the significance level, and the confidence interval are based on the average first sample subset characteristic values and the average second sample subset characteristic values.

In some embodiments, the obtaining the first sample set and the second sample set, for each sample, may include: obtaining a request associated with a first randomizing parameter; assigning the request to the first model or the second model based on the first randomizing parameter by using a first randomizing function; generating the first characteristic value for the sample based on the request and the model to which the request is assigned.

In some embodiments, the first randomizing parameter is user ID and the first randomizing function is to assign the request by even or odd number in a last digit of the user ID.

In some embodiments, the determining the average difference based on the average first sample subset characteristic values and the average second sample subset characteristic values may include: determining a first evaluation parameter related to central tendency of the average first sample subset characteristic values; determining a second evaluation parameter related to the central tendency of the average second sample subset characteristic values; determining the average difference based on the first evaluation parameter and the second evaluation parameter.

In some embodiments, the determining the significance level based on the average first sample subset characteristic values and the average second sample subset characteristic values may include: determining a third evaluation parameter related to the central tendencies of the average first sample subset characteristic values and the average second sample subset characteristic values; determining a first error based on difference between the first evaluation parameter and the third evaluation parameter and difference between the second evaluation parameter and the third evaluation parameter; determining a second error based on difference between the average first sample subset characteristic value and the third evaluation parameter and difference between the average second sample subset characteristic value and the third evaluation parameter; determining the significance level based on the first error and the second error.

In some embodiments, the determining the second error may include: determining a degree of freedom based on total number of the first sample subsets and the second sample subsets; determining the second error based the degree of freedom.

In some embodiments, the determining the confidence interval may include: obtaining a degree of confidence; determining the confidence interval associated with the degree of confidence based on the average difference, the degree of freedom and the second error.

In some embodiments, the determining the confidence interval may include: determining the confidence interval associated with the degree of confidence based on Student's t-distribution.

According to still another aspect of the present disclosure, a non-transitory computer readable medium, comprising at least one set of instructions for model evaluation, wherein when executed by at least one processor of a computer server, the at least one set of instructions directs the at least one processor to perform acts of: obtaining a first sample set and a second sample set, wherein the first sample set includes a plurality of first samples based on a first model, the second sample set includes a plurality of second samples based on a second model, and each of the first and second samples includes a characteristic value; dividing the first sample set into a plurality of first sample subsets, each first sample subset providing an average first sample subset characteristic value; divide the second sample set into a plurality of second sample subsets; each second sample subset providing an average second sample subset characteristic value; determine a final model between the first model and the second model based on an average difference, a significance level, and a confidence interval between the first model and the second model, wherein the average difference, the significance level, and the confidence interval are based on the average first sample subset characteristic values and the average second sample subset characteristic values.

### BRIEF DESCRIPTION OF THE DRAWINGS

The present disclosure is further described in terms of exemplary embodiments. The foregoing and other aspects of embodiments of present disclosure are made more evident in the following detail description, when read in conjunction with the attached drawing figures.

FIG. 1 is a block diagram of an exemplary system for model evaluation according to some embodiments;

FIG. 2 is a schematic diagram illustrating exemplary hardware and software components of a computing device according to some embodiments;

FIG. 3 is a block diagram illustrating an exemplary processing engine according to some embodiments;

FIG. 4 is a flowchart of an exemplary process and/or method for obtaining a first sample set based on a first model and/or a second sample set based on a second model according to some embodiments of the present disclosure;

FIG. 5 is a flowchart of an exemplary process and/or method for model evaluation according to some embodiments of the present disclosure;

FIG. 6 is a flowchart of an exemplary process and/or method for determining the average difference between the first model and the second model according to some embodiments of the present disclosure;

FIG. 7 is a flowchart of an exemplary process for determining the significance level associated with the first model and the second model according to some embodiments of the present disclosure;

FIG. 8 is a flowchart of an exemplary process and/or method for e determining the second error according to some embodiments of the present disclosure; and

FIG. 9 is a flowchart of an exemplary process and/or method for determining the confidence interval according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

The term “model” in the present disclosure may refer to a structure including a set of finitely operations and relations, while the structure may receive one or more inputs, and may generate one or more outputs based on the one or more inputs and the set of finitely operations and relations. For example, in the on-demand service, such as online taxi hailing, a request distribution model may be configured to distribute requests from passengers in an area to drivers in the same area. After a request is distributed as an input by a certain distribution model, a pick-up distance for the driver to pick up a passenger who has initiated the request may be generated as an output of the distribution model. Performances of the models may be evaluated by comparing different average pick-up distances based on different models. For example, for two distribution models, performance of a distribution model with a shorter pick-up distance is generally considered better than performance of another distribution model with a longer pick-up distance. The term “first model” and “second model” in the present disclosure may refer to different models for the same need. For example, in some embodiments of the present disclosure, “first model” and “second model” may be different models for distributing requests from passengers in an area to drivers in the same area. Though the current invention may be used to evaluate a plurality of models, the examples herein presented focus on the comparison of two models (e.g., designated as the “first model” and the “second model”).

The term “sample” in the present disclosure may refer to a combination of the one or more inputs and the one or more outputs related to a model. For example, a request, as well as certain actions (e.g., an acceptance of the request), values (e.g. pickup time) and parameters (e.g. pickup location and destination) associated with the request, may be considered as a sample of the model. The sample may also include one or more characteristic values related to the one or more outputs. For example, the pick-up distance may be considered as one characteristic value of the sample. The term “first sample” in the present disclosure may refer to sample of the first model, and the term “second sample” in the present disclosure may refer to sample of the second model.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

An aspect of the present disclosure relates to online systems and methods for model evaluation. According to the present disclosure, the systems and methods may evaluate model by determining a difference between outputs of different models, an estimated interval of the difference, and a credibility of the estimated interval. If the difference is significant, the estimated interval is a positive interval and the credibility is high, the model with better performance may be determined as a final model. The significant degree, the estimated interval and the credibility may be obtained by the conducting processing operations on the processing results of requests data.

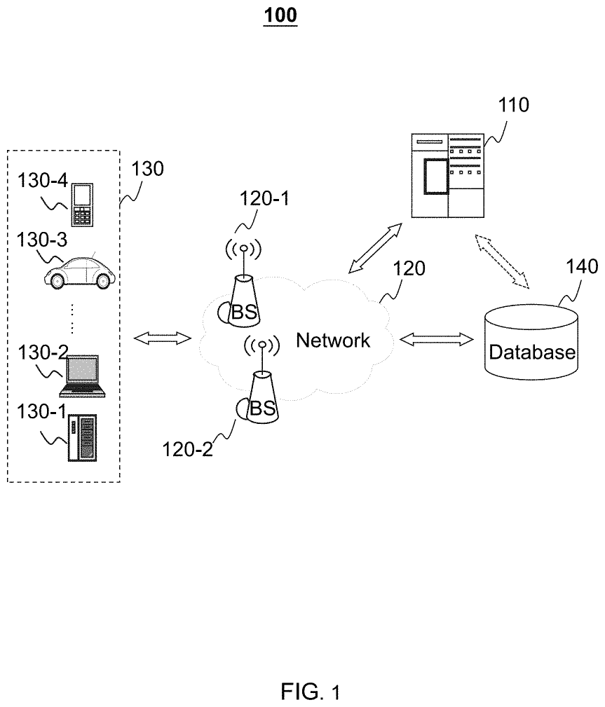

FIG. 1 is a block diagram of an exemplary system 100 for model evaluation according to some embodiments. System 100 may include a server 110, a network 120, a terminal 130, and a database 140. The server 110 may include a processing engine 112.

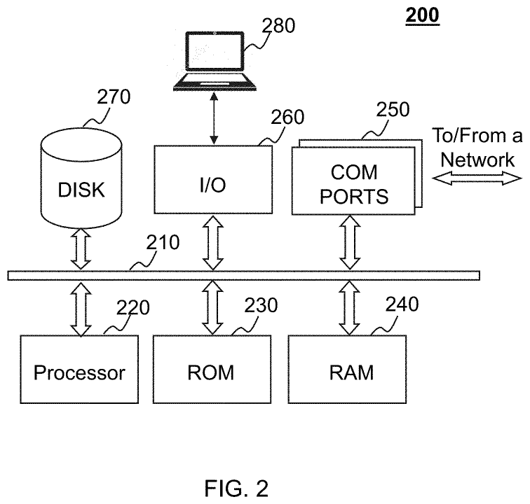

The server 110 may be configured to process information and/or data relating to a plurality of service requests, for example, the server 110 may evaluate performance of different models based on a plurality of samples related to the different models. In some embodiments, the server 110 may assign request to different models to generate different samples. For example, in the on-demand service, such as online taxi hailing, the server 110 may assign a request initiated by a passenger to a model to generate at least one output of the request based on the model, the request and the at least one output may be designated as a sample. In some embodiments, the server 110 may conduct mathematical processing on the different samples based on the characteristic values of the samples. For example, the server 110 may divide the samples associated with the same model into a plurality of groups and generate an average value for each group based on the characteristic values of the samples. The server 110 may also determine an average difference, a significance level, and/or a confidence interval based on different samples related to different models. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the terminal 130 and/or the database 140 via the network 120. As another example, the server 110 may be directly connected to the terminal 130 and/or the database 140 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the requests to perform one or more functions described in the present disclosure. For example, the processing engine 112 may obtain a request from the terminal 130 and assign the request to different models to determine a characteristic value of the request. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the terminal 130 may include a passenger terminal and a driver terminal. The passenger terminal and the driver terminal may be referred to as a user that may be an individual, a tool or other entity directly relating to the requests. In some embodiments, the terminal 130 may include a mobile device 130-1, a tablet computer 130-2, a laptop computer 130-3, and a built-in device 130-4 in a motor vehicle, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, built-in device in the motor vehicle 130-4 may include an onboard computer, an onboard television, etc. Merely by way of example, the terminal 130 may include a controller (e.g., a remote-controller).

The network 120 may facilitate exchange of information and/or data. In some embodiments, one or more components in the system 100 (e.g., the server 110, the terminal 130, and the database 140) may send and/or receive information and/or data to/from other component(s) in the system 100 via the network 120. For example, the server 110 may obtain/acquire service request from the terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or internet exchange points 120-1, 120-2, . . . , through which one or more components of the system 100 may be connected to the network 120 to exchange data and/or information.

The database 140 may store data and/or instructions. In some embodiments, the database 140 may store data obtained/acquired from the terminal 130. In some embodiments, the database 140 may store different models that executed or used by the server 110 to perform exemplary methods described in the present disclosure. In some embodiments, the database 140 may store different samples related to different models. In some embodiments, the database 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 140 may be connected to the network 120 to communicate with one or more components in the system 100 (e.g., the server 110, the terminal 130). One or more components in the system 100 may access the data or instructions stored in the database 140 via the network 120. In some embodiments, the database 140 may be directly connected to or communicate with one or more components in the system 100 (e.g., the server 110, the terminal 130, etc.). In some embodiments, the database 140 may be part of the server 110.

FIG. 2 illustrates a schematic diagram of an exemplary computing device according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the server 110, the terminal 130 and/or the database 140 may be implemented in hardware devices, software programs, firmware, or any combination thereof of a computer like computing device 200. For brevity, FIG. 2 depicts only one computing device. In some embodiments, the functions of the computing device, providing function that route planning may require, may be implemented by a group of similar platforms in a distributed mode to disperse the processing load of the system.

Computing device 200 may include a communication terminal 250 that may connect with a network that may implement the data communication. Computing device 200 may also include a processor 220 that is configured to execute instructions and includes one or more processors. In some embodiments, the processor 220 may obtain requests initiated by passengers and assign the requests to different models to generate different samples. In some embodiments, the combination of a request and output of the model which the request assigned to may be designated as a sample. In some embodiments, the processor 220 may conduct a mathematic processing on the different samples based on the characteristic values of the samples. For example, the processor 220 may divide the samples associated with the same model into a plurality of groups and generate an average value for each group based on the characteristic values of the samples. The processor 220 may also determine an average difference, a significance level, and/or a confidence interval based on different samples related to different models. In some embodiments, the schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by processor 220. Computing device 200 may also include an I/O device 260 that may support the input and output of data flows between computing device 200 and other components (e.g. a user interface 280). Moreover, computing device 200 may receive programs and data via the communication network.

Various aspects of methods of providing functions required by route planning and/or methods of implementing other steps by programs are described above. The programs of the technique may be considered as “products” or “artifacts” presented in the form of executable codes and/or relative data. The programs of the technique may be joined or implemented by the computer readable media. Tangible and non-volatile storage media may include any type of memory or storage that is applied in computer, processor, similar devices, or relative modules. For example, the tangible and non-volatile storage media may be various types of semiconductor storages, tape drives, disc drives, or similar devices capable of providing storage function to software at any time.

Some or all of the software may sometimes communicate via a network, e.g. Internet or other communication networks. This kind of communication may load a software from a computer device or a processor to another. For example, a software may be loaded from a management server or a main computer of model evaluation system 100 to a hardware platform in a computer environment, or to other computer environments capable of implementing the system. Correspondingly, another media used to transmit software elements may be used as physical connections among some of the equipment, for example, light wave, electric wave, or electromagnetic wave may be transmitted by cables, optical cables or air. Physical media used to carry waves, e.g. cable, wireless connection, optical cable, or the like, may also be considered as media of hosting software. Herein, unless the tangible “storage” media is particularly designated, other terminologies representing the “readable media” of a computer or a machine may represent media joined by the processor when executing any instruction.

A computer readable media may include a variety of forms, including but is not limited to tangible storage media, wave-carrying media or physical transmission media. Stable storage media may include compact disc, magnetic disk, or storage systems that are applied in other computers or similar devices and may achieve all the sections of model evaluation system 100 described in the drawings. Unstable storage media may include dynamic memory, e.g. the main memory of the computer platform. Tangible transmission media may include coaxial cable, copper cable and optical fiber, including circuits forming the bus in the internal of computing device 200. Wave-carrying media may transmit electric signals, electromagnetic signals, acoustic signals or light wave signals. And these signals may be generated by radio frequency communication or infrared data communication. General computer-readable media may include hard disk, floppy disk, magnetic tape, or any other magnetic media; CD-ROM, DVD, DVD-ROM, or any other optical media; punched cards, or any other physical storage media containing aperture mode; RAM, PROM, EPROM, FLASH-EPROM, or any other memory chip or magnetic tape; carrying waves used to transmit data or instructions, cable or connection devices used to transmit carrying waves, or any other program code and/or data accessible to a computer. Most of the computer readable media may be applied in executing instructions or transmitting one or more results by the processor.

Merely for illustration, only one processor 220 is described in the computing device 200. However, it should be note that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

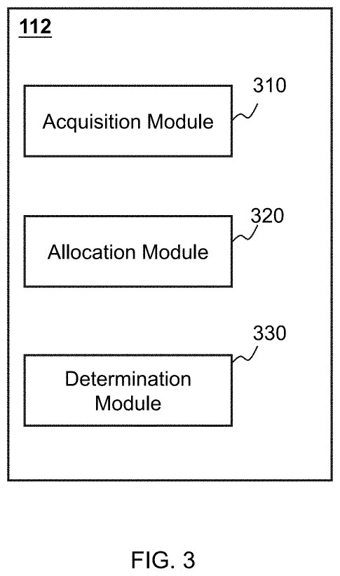

FIG. 3 is a block diagram illustrating an exemplary processing engine 112 according to some embodiments. The processing engine 112 may include an acquisition module 310, an allocation module 320, and a determination module 330. The modules may be hardware circuits of all or part of the processing engine 112. The modules may also be implemented as an application or set of instructions read and executed by the processing engine. Further, the modules may be any combination of the hardware circuits and the application/instructions. For example, the modules may be the part of the processing engine 112 when the processing engine is executing the application/set of instructions.

The acquisition module 310 may obtain a request associated with a first randomizing parameter. In some embodiments, the request may be related to a transportation service request initiated by a user, for example, an on-demand taxi service request. In some embodiments, the request may include original data associated with the transportation service, for example, the original data may include but not limited to the identification of the user, the request time, the location of the user, the destination, whether to accept carpooling, whether to accept dynamic price adjustment, or the like, or any combination thereof. The user may be a service requestor such as a passenger or a service provider such as a driver registered in the transportation service platform. In some embodiments, the first randomizing parameter may be the user ID, which uniquely identifies the user. The user ID may be any type of numerals, words, images or patterns, or a combination thereof. In some embodiments, the user ID may be a string of digital and/or alphabetic characters. In certain embodiments, the user ID may be a string of numbers. The following descriptions use the number-string user ID as an example to explain the embodiments of the present invention. It should be noted, however, that other randomizing methods and/or technologies may be utilized depending on the specific user ID format.

The allocation module 320 may obtain one or more models from the storage 140 and/or the hard disk 270. The allocation module 320 may be configured to assign the request to a first model or a second model. The first model and the second model may be related to a business index for an on-demand transportation service platform, including but not limited to deal rate of transportation service orders, accuracy rate of destination estimation, accuracy rate of departure location estimation, matching rate of carpooling passengers, acceptance rate of dynamic price adjustment, orders receiving rate of drivers, pick-up distance, or the like, or any combination thereof. The request may be assigned to the first model or the second model based on the first randomizing parameter and generate at least one output based on the model which the request assigned. For example, the requests may be assigned to the first model or the second model based on whether the last digit of the user ID is an odd number or an even number. The combination of the requests assigned to the first model and the at least one output associated to the requests may be designated as first samples (or part of first samples) and form a first sample set. The requests assigned to the second model and the at least one output associated to the requests may be designated as second samples (or part of second samples) and form a second sample set as second samples.

In some embodiments, the allocation module 320 may be further configured to divide the first sample set into a plurality of first sample subsets and to divide the second sample set into a plurality of second sample subsets based on the requests. In some embodiments, the allocation module 320 may divide the first sample set and the second sample set based on the last digit of the user ID (e.g., samples having a user ID with last digit of “1” are put into a same subset, within the first sample set) included in the request.

The determination module 330 may be configured to generate a plurality of values based on the first samples and the second samples. The plurality of values may include characteristic value, average first sample subset characteristic value, average second sample subset characteristic value, average difference, significant level, confidence level, or the like, or any combination thereof.

In some embodiments, the determination module 330 may be configured to generate a characteristic value for each first sample and second sample. The characteristic value may be an indicator for the business index determined by the first model and/or the second model.

In some embodiments, the determination module 330 may be configured to generate an average first sample subset characteristic value for each first sample subset and an average second sample subset characteristic value for each second sample subset. The average first sample subset characteristic value and the average second sample subset characteristic value may be a mathematical statistics value of the characteristic values. In some embodiments, the mathematical statistics value may be an average value, a variance, a standard deviation, a median, or the like, or any combination thereof.

In some embodiments, the determination module 330 may be configured to generate an average difference based on the average first sample subset characteristic values and the average second sample subset characteristic values. The average difference may represent the variation degree of the second model as compared with the first model.

In some embodiments, the determination module 330 may be configured to generate a significant level based on the average first sample subset characteristic values and the average second sample subset characteristic values. The significant level may represent the significance of the average difference.

In some embodiments, the determination module 330 may be configured to generate a confidence level based on the average first sample subset characteristic values and the average second sample subset characteristic values. The confidence level may represent a benefit range of the second model as compared with the first model under a certain degree of confidence.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the allocation module 320 may be integrated in the determination module 330 as a single module that may both assign requests to the first model or the second model and determine the plurality of values based on the requests. As another example, the determination module 330 may divide into five units of average first sample subset characteristic value determination unit, average second sample subset characteristic value determination unit, average difference determination unit, significance level determination unit, confidence interval determination unit to implement the functions of the determination module 330, respectively.

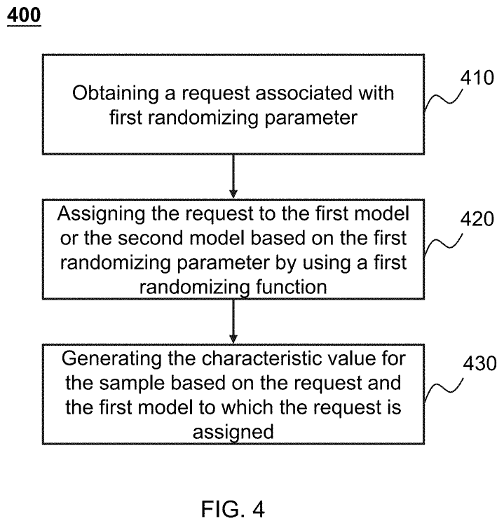

FIG. 4 is a flowchart of an exemplary process and/or method 400 for obtaining a first sample based on the first model and/or a second sample based on the second model. In some embodiments, the process 400 may be implemented in the system 100 illustrated in FIG. 1. For example, the process 400 may be stored in the database 140 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 410, the processor 220 may obtain a request associated with a first randomizing parameter. In some embodiments, the request may be related to a transportation service request, such as an online taxi hailing request, initiated by a passenger. In some embodiments, the request may include original data associated with the transportation service request, for example, the original data may include but not limited to the identification of the passenger (such as user ID), request time, location of the passenger, destination of the passenger, whether the passenger accepts carpooling, whether the passenger accepts dynamic price adjustment, or the like, or any combination thereof. In some embodiments, the first randomizing parameter may be the user ID, which uniquely identifies the user. The user ID may be any type of numerals, words, images or patterns, or a combination thereof. In some embodiments, the user ID may be a string of digital and/or alphabetic characters. In certain embodiments, the user ID may be a string of numbers. The following descriptions use the number-string user ID as an example to explain the embodiments of the present invention. It should be noted, however, that other randomizing methods and/or technologies may be utilized depending on the specific user ID format.

In step 420, the processor 220 may assign the request to the first model or the second model based on the first randomizing parameter by using a first randomizing function. In some embodiments, the first randomizing function may be configured to assign the request by even or odd number in a last digit of the user ID. For example, the processor 220 may assign the request with a user ID having an even last digit to the first model and assign the request with a user ID having an odd last digit to the second model. It should be noted that in some embodiments the assignment method may vary. The request with a user ID having an even last digit may be assigned to the second model and the request with a user ID having an odd last digit may be assigned to the first model. All such modifications are within the protection scope of the present disclosure.

In step 430, the processor 220 may generate the characteristic value for the sample based on the request and the model to which the request is assigned. In some embodiments, the characteristic value may be an indicator for the business index determined by the first model and/or the second model based on the original data included in the request. For example, the first model and the second model may be different models related to pick-up distance for a drive to pick up a passenger while receiving a request initiated by the passenger. If the first model and the second model are configured to distribute requests from passengers in an area to drivers in the same area, pick-up distance for the driver to pick up the passenger may be the indicator to evaluate the first model and the second model. In some embodiments, the characteristic value of each of the first and the second samples may be the pick-up distance value.

In some embodiments, each of the first sample and second sample may include two or more characteristic values. For example, while the first model and the second models are configured to distribute requests from passengers, each of the first sample and second sample may include a first characteristic value for pick-up distance and a second characteristic value for passenger satisfaction level. Accordingly, in certain embodiments, the evaluation of the first model and the second model may be based on two or more characteristic values and a final model is the model that perform better when all the characteristic values are taken into consideration. For example, in some embodiments, the first characteristic values are compared between the models and the second characteristic values are also compared. In some embodiments, the final result may be obtained by giving weight to the comparison results of each characteristic value and generate a comprehensive conclusion. For the purpose of clarity and simplicity, the following descriptions are directed to comparison of a single characteristic value.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 400. As another example, all the steps in the exemplary process/method 400 may be implemented in a computer-readable medium including a set of instructions. The instructions may be transmitted in the form of electronic current.

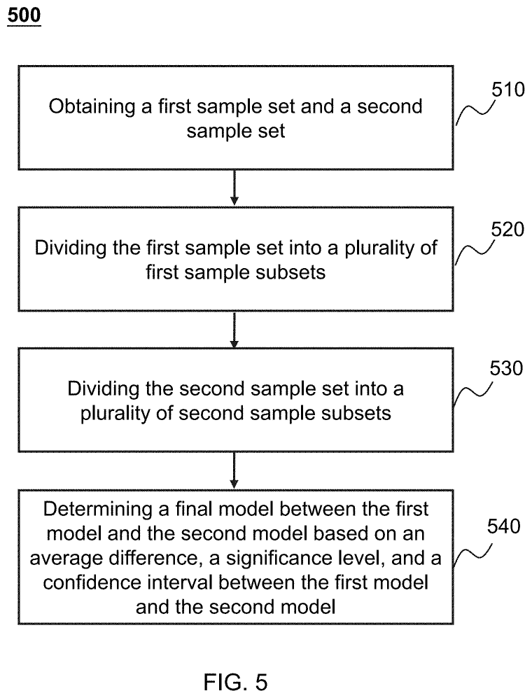

FIG. 5 is a flowchart of an exemplary process and/or method for model evaluation according to some embodiments of the present disclosure. In some embodiments, the process 500 may be implemented in the system 100 illustrated in FIG. 1. For example, the process 500 may be stored in the database 140 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 510, the processor 220 may obtain a first sample set and a second sample set from the storage 140 and/or the hard disk 270. In some embodiments, the first sample set may include a plurality of first samples associated with a first model, and the second sample set may include a plurality of second samples associated with a second model. In some embodiments, each sample of the first sample set and/or the second sample set may be related to a transportation service request initiated by a passenger. The first model and the second model may be related to an on-demand service, such as online taxi hailing. Each of the first samples and the second samples may include a characteristic value used to evaluate performance of the first model and the second model. In some embodiments, the characteristic value may include but not limited to deal rate of transportation service orders, accuracy rate of destination estimation, accuracy rate of departure location estimation, matching rate of carpooling passengers, acceptance rate of dynamic price adjustment, orders receiving rate of drivers, pick-up distance, or the like, or any combination thereof. For example, the first model and the second model may be different models related to pick-up distance for a drive to pick up a passenger while receiving a request initiated by the passenger. If the first model and the second model are configured to distribute requests from passengers in an area to drivers in the same area, pick-up distance for the driver to pick-up the passenger may be the indicator to evaluate the first model and the second model. The characteristic value of each of the first and the second samples may be the pick-up distance value. More details of the determination of the first samples and the second samples may be found in FIG. 4 and the description thereof.

In step 520, the processor 220 may divide the first sample set into a plurality of first sample subsets, for each first sample subset, the processor 220 may provide an average first sample subset characteristic value.

In some embodiments, the processor 220 may divide the first sample set into a plurality of first sample subsets based on the requests or the passengers initiated the requests. Merely by way of example, the processor 220 may divide the first sample set based on a user ID associated with the passenger initiated the requests. The user ID may be a string of numbers and the last digit may be any number from 0 to 9. In some embodiments, the first samples with the same last digit of the user ID may be assign to one first sample subset and the second samples with the same last digit of the user ID may be assign to one second sample subset.

Since each sample may have a characteristic value, an average first sample subset characteristic value of each first sample subset may be generated based on the characteristic values of first samples in the first sample subset. The average first sample subset characteristic value may be a mathematical statistics value of the characteristic values of the first samples in the first sample subset. In some embodiments, the mathematical statistics value may be an average value, a variance, a standard deviation, a median, or the like, or any combination thereof.

In step 530, the processor 220 may divide the second sample set into a plurality of second sample subsets, for each second sample subset, the processor 220 may provide an average second sample subset characteristic value.

In some embodiments, the division method for the second sample set may be the same method for the first sample set. The average second sample subset characteristic value may be the same kind of the mathematical statistics value with the average first sample subset characteristic value.

In step 540, the processor 220 may determine a final model between the first model and the second model based on an average difference, a significance level of the average difference, and a confidence interval between the first model and the second model.

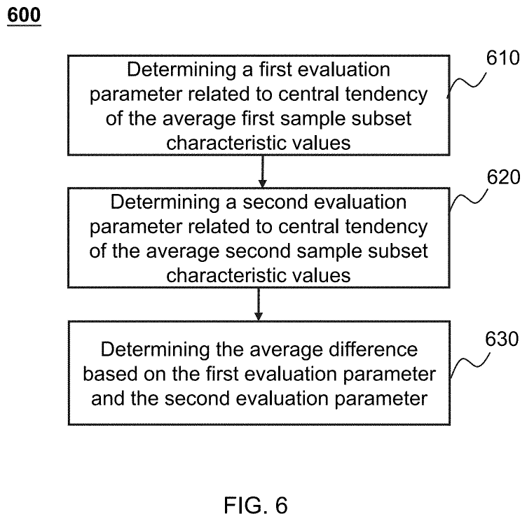

In some embodiments, the average difference between the first model and the second model may represent the variation degree of the second model as compared with the first model. More details of determination of the average difference may be found in FIG. 6 and the descriptions thereof.

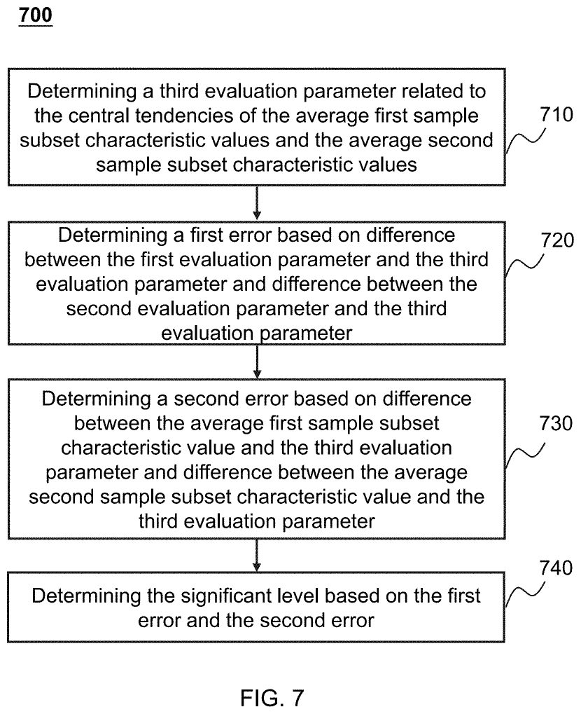

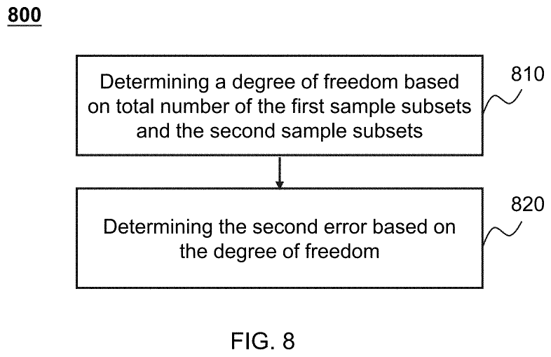

In some embodiments, the significance level may be used to verify the significant degree of the average difference. Influence factor of the average difference may include different models and different samples. When the processor 220 obtains the average difference between the first model and the second model, it would be necessary to determine which factor leads to the result of the average difference. For example, if the influence of different models is significance for the average difference, it would be reasonable to conclude that the significant degree of the average difference should be high, or the significance level should be high. If the influence of different samples is significance for the average difference, it would be reasonable to conclude that the significant degree of the average difference should be low, or the significance level should be low. More details of determination of the significance level may be found in FIGS. 7-8 and the descriptions thereof.

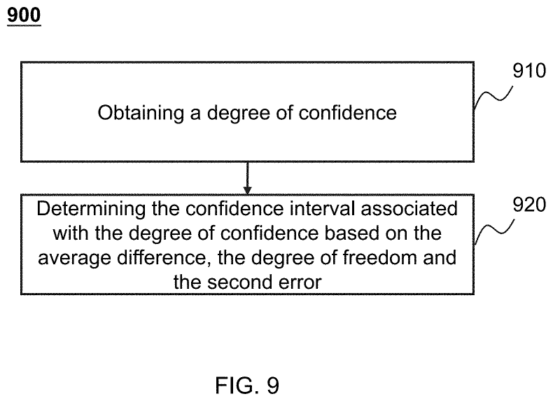

In some embodiments, the confidence interval may be a benefit range of the second model relative to the first model. For example, if the first model and the second model are used to determine the pick-up distance, after determining that the significance level is high, the processor 220 may determine a benefit range of distance caused by the second model. For example, the benefit range may be [3 meters, 25 meters]. The second model may decrease 3 meters to 25 meters pick-up distance compare with the first model. In some embodiments, the confidence interval may be a numerical interval. In some embodiments, the endpoint values of the confidence interval may be a positive value. In some embodiments, the endpoint values of the confidence interval may be a negative value. In some embodiments, the left endpoint value of the confidence interval may be a negative value and the right endpoint value of the confidence interval may be a positive value. More details of the determination of the confidence interval may be found in FIG. 9 and the descriptions thereof.

Under the situation that the average difference is significant, the significance level is high and the confidence interval is positive interval, the processor 220 may determine the second model as the final model. Otherwise, the processor 220 may determine the first model as the final model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 500. As another example, all the steps in the exemplary process/method 500 may be implemented in a computer-readable medium including a set of instructions. The instructions may be transmitted in a form of electronic current.

FIG. 6 is a flowchart of an exemplary process and/or method 600 for determining the average difference between the first model and the second model according to some embodiments of the present disclosure. In some embodiments, the process 600 may be implemented in the system 100 illustrated in FIG. 1. For example, the process 600 may be stored in the database 140 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 610, the processor 220 may determine a first evaluation parameter related to a central tendency of the average first sample subset characteristic values. In some embodiments, the first evaluation parameter may be a representative value of the central tendency of the average first sample subset characteristic values. In some embodiments, the representative value may be an arithmetic average of the average first sample subset characteristic values, a harmonic average of the average first sample subset characteristic values, a geometrical average of the average first sample subset characteristic values, a median of the average first sample subset characteristic values, or the like, or any combination thereof. For example, if the average first sample subset characteristic values are denoted as (x_{A1}, x_{A2}, . . . x_{An}_{_{A}}), wherein x_{An}_{_{A}} is an average first sample subset characteristic value of a certain first sample subset, and n_{A} is an integer and denote number of the first sample subset, the first evaluation parameter a_{A} may be determined by the following equation:

$${a}_{A} = \frac{1}{{n}_{A}} {\sum }_{i = 1}^{{n}_{A}} {x}_{A i} , \qquad ( 1 )$$

wherein x_{Ai} denotes a certain average first sample subset characteristic value of a certain first sample subset.

In step 620, the processor 220 may determine a second evaluation parameter related to central tendency of the average second sample subset characteristic values. In some embodiments, the second evaluation parameter may be a representative value of the central tendency of the average second sample subset characteristic values. In some embodiments, the representative value may be an arithmetic average of the average second sample subset characteristic values, a harmonic average of the average second sample subset characteristic values, a geometrical average of the average second sample subset characteristic values, a median of the average second sample subset characteristic values, or the like, or any combination thereof. For example, if the average second sample subset characteristic values are denoted as (x_{B1}, x_{B1}, . . . x_{Bn}_{_{B}}), wherein x_{Bn}_{_{B}} denotes an average second sample subset characteristic value of a certain second sample subset, and n_{B} denotes a number of the second sample subset, the second evaluation parameter a_{B} may be determined by the following equation:

$${a}_{B} = \frac{1}{{n}_{B}} {\sum }_{j = 1}^{{n}_{B}} {x}_{B j} , \qquad ( 2 )$$

wherein x_{Bi} denotes a certain average second sample subset characteristic value of a certain second sample subset.

In step 630, the processor 220 may obtain the average difference based on the first evaluation parameter and the second evaluation parameter.

In some embodiments, after determining the first evaluation parameter and the second evaluation parameter, the processor 220 may obtain the average difference a_{AB} by the following equation:

a_{AB}=a_{A}−a_{B} (3)

The average difference may be a positive or a negative value. The average difference a_{AB} may represent difference between performance of the first model and performance of the second model. For example, if the first model and the second model are configured to determine the pick-up distance, while the first evaluation parameter is 756 meters and the second evaluation parameter is 743 meters, the processor 220 may determine the average difference as 13 meters. The 13 meters may represent decrement of the pick-up distance caused by the second model. As another example, if the average difference is −13 meters, the −13 meters may represent increment of the pick-up distance caused by the second model.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 600. As another example, all the steps in the exemplary process/method 600 may be implemented in a computer-readable medium including a set of instructions. The instructions may be transmitted in the form of electronic current.

FIG. 7 is a flowchart of an exemplary process and/or method 700 for determining the significance level associated with the first model and the second model according to some embodiments of the present disclosure. In some embodiments, the process 700 may be implemented in the system 100 illustrated in FIG. 1. For example, the process 700 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 710, the processor 220 may determine a third evaluation parameter related to a central tendency of the average first sample subset characteristic values and the average second sample subset characteristic values. In some embodiments, the third evaluation parameter may be a representative value of the central tendency of the average first sample subset characteristic values and average second sample subset characteristic values. In some embodiments, the representative value may be an arithmetic average of the average first sample subset characteristic values and the average second sample subset characteristic values, a harmonic average of the average first sample subset characteristic values and the average second sample subset characteristic values, a geometrical average of the average first sample subset characteristic values and the average second sample subset characteristic values, a median of the average first sample subset characteristic values and the average second sample subset characteristic values, or the like, or any combination thereof. As described above, if the first evaluation parameter is denoted as a_{A} and the second evaluation parameter is denoted as a_{B}, the third average a may be determined by the following equation:

$$a = \frac{{a}_{A} + {a}_{B}}{2} \qquad ( 4 )$$

In step 720, the processor 220 may determine a first error based on difference between the first evaluation parameter and the third evaluation parameter and difference between the second evaluation parameter and the third evaluation parameter.

In some embodiments, the first error may represent a discrepancy caused by a difference between the first model and the second model, among the average first sample subset characteristic values and average second sample subset characteristic values. In some embodiments, the processor 220 may determine the first error ME₁ by the following equation:

ME₁=Σ_{i=A}^{B}nᵢ(aᵢ−a)² (5)

In the Equation (5), aᵢ may denote the first evaluation parameter or the second evaluation parameter. Specifically, when i equals to A, aᵢ may denote the first evaluation parameter, when i equals to B, aᵢ may denote the second evaluation parameter. a may denote the third evaluation parameter.

In step 730, the processor 220 may determine a second error based on a difference between the average first sample subset characteristic value and the third evaluation parameter and a difference between the average second sample subset characteristic value and the third evaluation parameter. Thus, the second error may be caused by a random error irrelative to the first model per se and the second model per se and relative to the differences between different samples. In some embodiments, the second error may be a sum of squares of the differences between average first sample subset characteristic values and the first evaluation parameter and squares of difference between average second sample subset characteristic values and the second evaluation parameter.

The processor 220 may determine an initial value E₂ as the second error ME₂ by the following equation:

E₂=Σ_{i=A}^{B}Σⱼ₌₁ⁿ^{ᵢ}(xᵢⱼ−aᵢ)² (6)

In Equation (6), xᵢⱼ is the one of the average first sample subset characteristic values or the average second sample subset characteristic values, specifically, when i equals to A, xᵢⱼ may denote an average first sample subset characteristic value, when i equals to B, xᵢⱼ may denote an average second sample subset characteristic value. aᵢ may denote the first evaluation parameter or the second evaluation parameter, specifically when i equals to A, aᵢ may denote the first evaluation parameter, when i equals to B, aᵢ may denote the second evaluation parameter. After obtaining the initial value of the second error, the processor 220 may perform a method to determine the second error. More details of the method for determining the second error may be found in FIG. 8 and the descriptions thereof.

In step 740, the processor 220 may determine the significance level based on the first error and the second error.

In some embodiments, the significance level may be used to verify the significant degree of the average difference caused by an influence factor. The influence factor causing the average difference may include model difference and/or sample difference. Model difference may refer to the innate difference between structure of the first model and structure of the second model. Sample difference may refer to difference between the first samples and the second samples due to original data selection. The processor 220 may determine whether the models rather than the samples have a great influence on the average difference.

In some embodiments, a ratio R between the first error and the second error may firstly be determined by the following equation:

R=ME₁/ME₂ (7)

Then, in certain embodiments, the processor 220 may determine the significance level S based on the ratio and an F testing table. In some embodiments, the processor 220 may compare the ratio with an F testing value obtained from the F testing table under a testing level. The testing level may be 0.1, 0.05, 0.025, 0.01, or the like. In some embodiments, if the ratio is larger than the F testing value, the processor 220 may continue to compare the ratio with another F testing value under a smaller testing level until the ratio is smaller than the F testing value. The smallest testing level may be designated as the significance level. The smaller the significance level, the more significant degree of the average difference caused by models.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 700. As another example, all the steps in the exemplary process/method 700 may be implemented in a computer-readable medium including a set of instructions. The instructions may be transmitted in the form of electronic current.

FIG. 8 is a flowchart of an exemplary process and/or method 800 for determining the second error according to some embodiments of the present disclosure. In some embodiments, the process 800 may be implemented in the system 100 illustrated in FIG. 1. For example, the process 800 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 810, the processor 220 may determine a degree of freedom based on total number of the first sample subsets and the second sample subsets.

In some embodiments, the degree of freedom is the number of values that are free to vary. For example, if total count of numbers is 4 and the average value of the 4 numbers is 5, after randomly determining the values of three numbers as 4, 2 and 5, the value of the fourth number must be 9. In this example, the degree of freedom may be 3 because only 3 numbers are free to change. In some embodiments, the degree of freedom DF is determined by the following equation:

DF=n−k (8)

Where n may denote the total number of values and k is the number of factors influencing the values. Merely by way of example, if the total number of the first sample subsets and the second sample subsets is (n_{A}+n_{B}) and the influence factors are models and original data, the degree of freedom DF may be determined as (n_{A}+n_{B}−2).

In step 820, the processor 220 may determine the second error based on the degree of freedom. In some embodiments, the second error ME₂ may be determined as E₂/(n_{A}+n_{B}−2).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 800. As another example, all the steps in the exemplary process/method 800 may be implemented in a computer-readable medium including a set of instructions. The instructions may be transmitted in the form of electronic current.

FIG. 9 is a flowchart of an exemplary process and/or method 900 for determining the confidence interval according to some embodiments of the present disclosure. In some embodiments, the process 900 may be implemented in the system 100 illustrated in FIG. 1. For example, the process 900 may be stored in the database 150 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In step 910, the processor 220 may obtain a degree of confidence. In some embodiments, the degree of confidence α may represent the reliability of the confidence interval. In some embodiments, the degree of confidence may be 90%, 95%, 97.5%, 99%, or the like.

In step 920, the processor 220 may determine the confidence interval associated with the degree of confidence based on the average difference, the degree of freedom and the second error. In some embodiments, the confidence interval may represent an interval range of difference between possible characteristic values associated with a new request based respectively on the first model and the second model. For example, the difference between the pick-up distance of the new request determined by the first model and the pick-up distance of the new request determined by the second model may belong to the interval range. The degree of confidence may represent the probability that the difference falls within the interval range. In some embodiments, each of the average first sample subset characteristic values and the average second sample subset characteristic values xᵢⱼ may be expressed as mᵢ+eᵢⱼ, where the mᵢ is the theoretical expected value, eᵢⱼ is the deviation caused by original data difference. The confidence interval may be the difference between the theoretical expected values determined by the first model and the second model.

In some embodiments, eᵢⱼ may comply with normal distribution N (0, σ²). Therefore, xᵢⱼ may comply with normal distribution N (mᵢ, σ²). Further, the average difference a may comply with normal distribution N (m_{A} m_{B},σ²/n_{A}+σ²/n_{B}), wherein m_{A} denotes the theoretical expected value of the average first sample subset characteristic values, and m_{B} denotes the theoretical expected value of the average second sample subset characteristic values. In some embodiments, transformation form of the average difference may comply with standard normal distribution, as the following formula:

$$\sqrt{\frac{{n}_{A} {n}_{B}}{{n}_{A} + {n}_{B}}} [ ( {a}_{A} - {a}_{B} ) - ( {m}_{A} - {m}_{B} ) ] / σ \text{∼} N ( 0 , 1 ) \qquad ( 9 )$$

Since the second error ME₂ may be unbiased estimate of the variance σ² of the deviation e, the Formula (9) described above may be converted into the expression below according to Student's t-distribution:

$$\sqrt{\frac{{n}_{A} {n}_{B}}{{n}_{A} + {n}_{B}}} [ ( {a}_{A} - {a}_{B} ) - ( {m}_{A} - {m}_{B} ) ] / M {E}_{2} \text{∼} {t}_{{n}_{A} + {n}_{B} - 2} \qquad ( 10 )$$

where the n_{A}+n_{B}−2 is the degree of freedom determined in step 810. Under the degree of confidence α obtained in step 910, the confidence interval may be determined by the following formula:

$$( {a}_{A} - {a}_{B} ) - \sqrt{\frac{{n}_{A} {n}_{B}}{{n}_{A} + {n}_{B}}} \cdot {ME}_{2} \cdot {t}_{{n}_{A} + {n}_{B} - 2} ( \frac{1 - α}{2} ) \leq ( {m}_{A} - {m}_{B} ) \leq ( {a}_{A} - {a}_{B} ) + \sqrt{\frac{{n}_{A} {n}_{B}}{{n}_{A} + {n}_{B}}} \cdot {ME}_{2} \cdot \\ {t}_{{n}_{A} + {n}_{B} - 2} ( \frac{1 - α}{2} ) \qquad ( 11 )$$

wherein (m_{A}−m_{B}) denotes the confidence interval, and (a_{A}−a_{B}) denotes the average difference, ME₂ denotes the second error, and

$${t}_{{n}_{A} + {n}_{B} - 2} ( \frac{1 - α}{2} )$$

denotes a Student's t-distribution value under the degree of freedom n_{A}+n_{B}−2 and the degree of confidence α.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 900. As another example, all the steps may be implemented in a computer-readable medium including a set of instructions. The instructions may be transmitted in the form of electronic current.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
one or more storage media comprising a set of instructions for model evaluation; and
one or more processors configured to communicate with the one or more storage media, wherein when executing the set of instructions, the one or more processors are directed to:
(a) obtain a first sample set and a second sample set, wherein:
(i) the first sample set includes a plurality of first samples based on a first model,
(ii) the second sample set includes a plurality of second samples based on a second model, and
(iii) each of the first and second samples includes a characteristic value,
(b) divide the first sample set into a plurality of first sample subsets, each first sample subset providing an average first sample subset characteristic value;
(c) divide the second sample set into a plurality of second sample subsets; each second sample subset providing an average second sample subset characteristic value;
(d) determine a final model between the first model and the second model based on an average difference, a significance level, and a confidence interval between the first model and the second model, wherein the average difference, the significance level, and the confidence interval are based on the average first sample subset characteristic values and the average second sample subset characteristic values.

2. The system of claim 1, wherein to obtain the first sample set and the second sample set, for each sample, the one or more processors are further directed to:
obtain a request associated with a first randomizing parameter;
assign the request to the first model or the second model based on the first randomizing parameter by using a first randomizing function; and
generate the characteristic value for the sample based on the request and the model to which the request is assigned.

3. The system of claim 2, wherein the first randomizing parameter is user ID and the first randomizing function is to assign the request by even or odd number in a last digit of the user ID.

4. The system of claim 1, wherein to determine the average difference based on the average first sample subset characteristic values and the average second sample subset characteristic values, the one or more processors are directed to:
determine a first evaluation parameter related to central tendency of the average first sample subset characteristic values;
determine a second evaluation parameter related to the central tendency of the average second sample subset characteristic values;
determine the average difference based on the first evaluation parameter and the second evaluation parameter.

5. The system of claim 4, wherein to determine the significance level based on the average first sample subset characteristic values and the average second sample subset characteristic values, the one or more processors are directed to:
determine a third evaluation parameter related to the central tendencies of the average first sample subset characteristic values and the average second sample subset characteristic values;
determine a first error based on difference between the first evaluation parameter and the third evaluation parameter and difference between the second evaluation parameter and the third evaluation parameter;
determine a second error based on difference between the average first sample subset characteristic value and the third evaluation parameter and difference between the average second sample subset characteristic value and the third evaluation parameter; and,
determine the significance level based on the first error and the second error.

6. The system of claim 5, wherein to determine the second error, the one or more processors are further directed to:
determine a degree of freedom based on total number of the first sample subsets and the second sample subsets; and
determine the second error based on the degree of freedom.

7. The system of claim 6, wherein to determine the confidence interval, the one or more processors are directed to:
obtain a degree of confidence;
determine the confidence interval associated with the degree of confidence based on the average difference, the degree of freedom and the second error.

8. The system of claim 7, wherein to determine the confidence interval, the one or more processors are directed to:
determine the confidence interval associated with the degree of confidence based on Student's t-distribution.

9. A method for model evaluation, comprising:
(a) obtaining, by at least one computer, a first sample set and a second sample set, wherein:
(i) the first sample set includes a plurality of first samples based on a first model,
(ii) the second sample set includes a plurality of second samples based on a second model, and
(iii) each of the first and second samples includes a characteristic value,
(b) dividing, by the at least one computer, the first sample set into a plurality of first sample subsets, each first sample subset providing an average first sample subset characteristic value;
(c) dividing, by the at least one computer, the second sample set into a plurality of second sample subsets; each second sample subset providing an average second sample subset characteristic value;
(d) determining, by the at least one computer, a final model between the first model and the second model based on an average difference, a significance level, and a confidence interval between the first model and the second model, wherein the average difference, the significance level, and the confidence interval are based on the average first sample subset characteristic values and the average second sample subset characteristic values.

10. The method of claim 9, wherein obtaining the first sample set and the second sample set, for each sample, includes:
obtaining a request associated with a first randomizing parameter;
assigning the request to the first model or the second model based on the first randomizing parameter by using a first randomizing function; and
generating the first characteristic value for the sample based on the request and the model to which the request is assigned.

11. The method of claim 10, wherein the first randomizing parameter is user ID and the first randomizing function is to assign the request by even or odd number in a last digit of the user ID.

12. The method of claim 9, wherein determining the average difference based on the average first sample subset characteristic values and the average second sample subset characteristic values includes:
determining a first evaluation parameter related to central tendency of the average first sample subset characteristic values;
determining a second evaluation parameter related to the central tendency of the average second sample subset characteristic values;
determining the average difference based on the first evaluation parameter and the second evaluation parameter.

13. The method of claim 12, wherein determining the significance level based on the average first sample subset characteristic values and the average second sample subset characteristic values includes:
determining a third evaluation parameter related to the central tendencies of the average first sample subset characteristic values and the average second sample subset characteristic values;
determining a first error based on difference between the first evaluation parameter and the third evaluation parameter and difference between the second evaluation parameter and the third evaluation parameter;
determining a second error based on difference between the average first sample subset characteristic value and the third evaluation parameter and difference between the average second sample subset characteristic value and the third evaluation parameter; and,
determining the significance level based on the first error and the second error.

14. The method of claim 13, wherein determining the second error includes:
determining a degree of freedom based on total number of the first sample subsets and the second sample subsets; and
determining the second error based the degree of freedom.

15. The method of claim 14, wherein determining the confidence interval includes:
obtaining a degree of confidence;
determining the confidence interval associated with the degree of confidence based on the average difference, the degree of freedom and the second error.

16. The method of claim 15, wherein determining the confidence interval includes:
determining the confidence interval associated with the degree of confidence based on Student's t-distribution.

17. A non-transitory computer readable medium, comprising at least one set of instructions for model evaluation, wherein when executed by at least one processor of a computer server, the at least one set of instructions directs the at least one processor to perform acts of:
(a) obtaining, by the at least one processor, a first sample set and a second sample set, wherein:
(i) the first sample set includes a plurality of first samples based on a first model,
(ii) the second sample set includes a plurality of second samples based on a second model, and
(iii) each of the first and second samples includes a characteristic value,
(b) dividing, by the at least one processor, the first sample set into a plurality of first sample subsets, each first sample subset providing an average first sample subset characteristic value;
(c) divide the second sample set into a plurality of second sample subsets;
each second sample subset providing an average second sample subset characteristic value;
(d) determine a final model between the first model and the second model based on an average difference, a significance level, and a confidence interval between the first model and the second model, wherein the average difference, the significance level, and the confidence interval are based on the average first sample subset characteristic values and the average second sample subset characteristic values.

18. The non-transitory computer readable medium of claim 17, wherein determining the average difference based on the average first sample subset characteristic values and the average second sample subset characteristic values includes:
determining a first evaluation parameter related to central tendency of the average first sample subset characteristic values;
determining a second evaluation parameter related to the central tendency of the average second sample subset characteristic values; and
determine the average difference based on the first evaluation parameter and the second evaluation parameter.

19. The non-transitory computer readable medium of claim 18, wherein determining the significance level based on the average first sample subset characteristic values and the average second sample subset characteristic values includes:
determining a third evaluation parameter related to the central tendencies of the average first sample subset characteristic values and the average second sample subset characteristic values;
determining a first error based on difference between the first evaluation parameter and the third evaluation parameter and difference between the second evaluation parameter and the third evaluation parameter;
determining a second error based on difference between the average first sample subset characteristic value and the third evaluation parameter and difference between the average second sample subset characteristic value and the third evaluation parameter; and,
determine the significance level based on the first error and the second error.

20. The non-transitory computer readable medium of claim 19, wherein determining the confidence interval includes:
determining a degree of confidence;
determining a degree of freedom based on total number of the first sample subsets and the second sample subsets; and
determining the confidence interval associated with the degree of confidence based on the average difference, the degree of freedom and the second error.
